(19) United States
(12) Patent Application Publication
(10) Pub. No.: US 2007/0072631 A1
(43) Pub. Date: Mar. 29, 2007

(54) Method and apparatus of gauging message freshness in terms of context

(75) Inventors: Von A. Mock, Boynton Beach, FL (US); Mark A. Barros, Wellington, FL (US); David J. Hayes, Lake Worth, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/233,884

(22) Filed: Sep. 23, 2005

(51) Int. Cl. H04Q 7/20

(52) U.S. Cl. 455/466

(57) ABSTRACT

A wireless communication device (200) capable of gauging message freshness from the context of a receiver of a message response can include a transceiver (202) and a processor (206) coupled to the transceiver. The transceiver can be programmed to determine (312) if a message response is stale from the context of a receiver of the message response and send (318) a request for a second message response if the message response is determined as being stale. The communication device can be further programmed to determine if the message response is stale by determining if the message response is sent after a predetermined time after receipt of the message response or by determining if the message response is sent after an estimated time after a request for the message response.

### FIELD OF THE INVENTION

This invention relates in general to mobile communication devices, and more particularly to gauging freshness of status reporting in response to events experienced primarily by the receiver of status information.

### BACKGROUND OF THE INVENTION

Mobile communication devices are in widespread use and have become especially common in metropolitan areas. Originally these devices supported mobile radio telephony service, allowing users to both communicate without a land line telephone, and to move while engaged in a telephone call. More recently, however, these devices have been developed to support a wide variety of communication and personal services. Most mobile communication devices presently sold include a network interface for sending and receiving data and data messages. The ability to engage in data communications has transformed mobile communication devices into personal communication assistants, allowing for a wide variety of applications to be used on the mobile communication device, including application for portable application environments, such as Java.

The advancement of mobile communications has enabled society to be more mobile, and many people depend on their mobile communication device to keep in touch, not just with business associates, but with friends and family as well. Many occupations require frequent travel, and thus concerns about the traveler's safety. Of course, a person could simply use the mobile communication device to call home. However, such calls may be charged against the person's account and may interrupt both parties to such calls at inopportune times. There are presently “man-down” buttons used on mobile communication devices such as public safety two-way radios that, once activated, indicate the user of the radio requires assistance. A “man-down” message receives a high priority in the communication system, and once activated the “man down” feature continuously transmits information which is given high priority by the communication system until the situation is resolved. This form of alert and status reporting requires significant system resources as well as consuming significant power from the mobile communication device's battery. Certainly for less urgent status reporting the dedication of system resources and consumption of power are not necessary

The responses from a “Message Read” within the multimedia messaging service (MMS) standard and from typical mail applications provide timely information to when a receiver of a message physically read the message. Sometimes a user receiving a message is busy within tasks and may not immediately respond to an “I'm OK” message request within a personal and family security device typically embodied by a portable mobile wireless device such as a cellular phone. The user receiving the I'm OK message response after delaying to actually read the message can have a false sense of assurance that the sender is OK at the present time due to the delay.

U.S. Pat. No. 6,603,389 by Motorola, Inc. entitled “Method for indicating a delinquent response to a message from a selective call device” discusses a method of determining if a message is delinquent by monitoring for a response within a given time period. If no response is received within the given time period, then the user is presented with an indication of a delinquent message. In the context of family security device, the response may be received in the form of a “Message Read” flag, but the assurance of freshness of the response is not assured

### SUMMARY OF THE INVENTION

Embodiments in accordance with the present invention can assure that a message response is either fresh or that an update for the message response is requested when the message response is stale.

In a first embodiment of the present invention, a method of gauging message freshness in terms of context can include the steps of determining if a message response is stale from the context of a receiver of the message response and sending a request for a second message response if the message response is determined as being stale. Determining if the message response is stale can be done by determining if the message response is sent after a predetermined time after receipt of the message response or by determining if the message response is sent after an estimated time after a request for the message response or by determining if the message response is sent from an unanticipated location or in response to an unanticipated event as defined in a profile in the receiver of the message response. Determining if the message response is stale can be done by determining if the message response is read in a location that is different from the location where the message response was received or by determining if the message response is read during an event that is different from an event occurring during receipt of the message response. In one particular embodiment, the method can further monitor a Message Read (MR) Flag of an “I'm OK” message in context of the receiver of the MR Flag or an environment of the receiver of the MR Flag. The method can further generate the request for the second message response if the MR flag is received after a predetermined time period defined by the context of the user of the receiver of the MR Flag. The context of the receiver of the MR Flag along with a profile of one or more members receiving the I'm OK message can be used to determine if an updated “I'm OK” message is required to be sent in response to the MR Flag.

In a second embodiment of the present invention, a wireless communication device capable of gauging message freshness from the context of a receiver of a message response can include a transceiver and a a processor coupled to the transceiver. The transceiver can be programmed to determine if a message response is stale from the context of a receiver of the message response and send a request for a second message response if the message response is determined as being stale. The communication device can be further programmed to determine if the message response is stale by determining if the message response is sent after a predetermined time after receipt of the message response or by determining if the message response is sent after an estimated time after a request for the message response. The communication device can also determine if the message response is stale by determining if the message response is sent from an unanticipated location or during an unanticipated event as defined in a sender's profile or a receiver's profile or if the message response is read in a location that is different from the location where the message response was received or is read during an event that is different from an event occurring during receipt of the message response. In one particular embodiment, the communication device can further monitor a Message Read (MR) Flag of an “I'm OK” message in context of the receiver of the MR Flag or an environment of the receiver of the MR Flag. The communication device can further generate the request for the second message response if the MR flag is received after a predetermined time period defined by the context of the user of the receiver of the MR Flag. The context of the receiver of the MR Flag along with a profile of one or more members receiving the I'm OK message can be used to determine if an updated “I'm OK” message is required to be sent in response to the MR Flag.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 shows a system diagram of a mobile communication system and mobile communication devices having personal status reporting or message response capability in accordance with an embodiment of the present invention.

FIG. 2 shows a block schematic diagram of a mobile communication device having personal status reporting or message response capability in accordance with and embodiment of the present invention.

FIG. 3 shows a flow chart diagram of a method of gauging message freshness in terms of context in accordance with an embodiment of the present invention.

FIG. 4 is a timing diagram illustrating a specific method of gauging message freshness in term so context in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

As discussed above, a user of a communication device receiving a message can be busy within tasks and may not immediately respond to an “I'm OK” message request within a personal and family security device typically embodied by a portable mobile wireless device such as a cellular phone. The user receiving the I'm OK message response after delaying to actually read the message can have a false sense of assurance that the sender is OK at the present time due to the delay. In such a scenario, where from the context of the receiver of a I'm OK message response has an indication that the message response is stale, an updated “I'm OK” or other status can be requested because of the receiver's context has changed due to location, time or event.

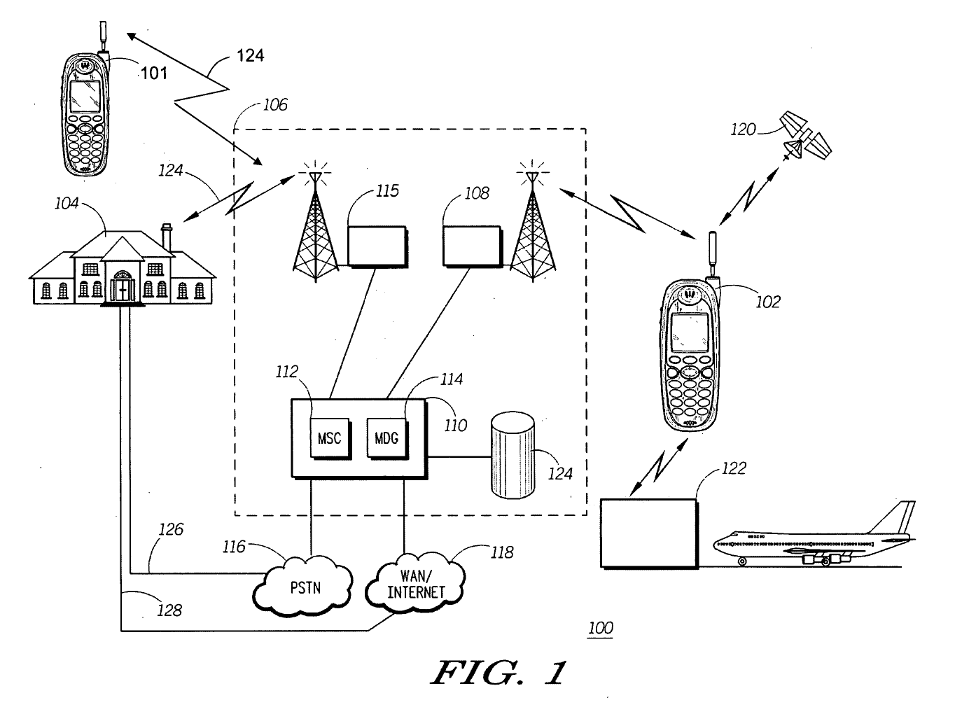

Referring now to FIG. 1, there is shown a block schematic diagram 100 of mobile communication devices 101 and 102 having personal status reporting and receiving capability in accordance with the invention. The status of the user may be reported to, for example, the user's home 104 or a third party's mobile communication 101. The mobile communication device 101 and/or 102 receives communication service from a communication system 106 via a base station 108. The communication system 100 can include a central office 110 that handles call processing and typically includes a mobile switching center 112 and a mobile data gateway 114. The mobile switching center provides telephony communication and switching functionality, and connects calls both to other mobile communication device users, other base stations 115, as well as to the public switched telephony network 116. The mobile data gateway 114 facilitates data communication, such as packet data communication, and provides connectivity to wide area networks, such as the Internet 118.

The user of the mobile communication device 102 can provide event criteria to an event processor of the mobile communication device. The information entered provides criteria for determining the occurrence of an event and can be stored in an event (or other context) descriptor file in the mobile communication device. In one embodiment of the invention receiving a status request message from a remote party is a default event, and the mobile communication device responds to the reception of the message in accordance with the method taught herein. The types of events that may be defined depend upon the design of the mobile communication device. It is contemplated that the mobile communication device may be equipped with a variety of subsystems such as, for example, a satellite positioning subsystem, a wireless local area network subsystem, and so on. Different equipment allows the mobile communication device to detect different environmental parameters, and thus detect the occurrence of events in different ways.

For example, as the user travels to other regions, the mobile communication device may detect that the user has entered a new serving region upon receiving communication service in the new region by detecting a region code in a broadcast control channel transmitted by the base station. The region code provides a rough geographic location parameter, and the mobile communication device can detect when the region code changes, such as when moving from one state or province to another, or from one country to another. Alternatively, the base station may transmit it particular geographic location in latitude and longitude, for example. Upon receiving the geographic location information for the base station, the mobile communication device compares it to event descriptors relating to geographic location, and if the present geographic location is substantially equal to the geographic location parameter in an event descriptor, the mobile communication device determines than an event has occurred and proceeds in accordance with the present invention. Geographic location may be used to infer that the user has arrived somewhere, such as at an airport upon landing, for example, and thus the user may enter geographic location of a place to which the user will be traveling to set up the event, resulting in a status report. Geographic location may also be determined in other ways, such as by use of a satellite positioning subsystem of the mobile communication device receiving satellite positioning signals from satellite positioning satellites 120. Once the satellite positioning subsystem has determined the present geographic location of the mobile communication device, the mobile communication device then determines if an event has occurred as defined by the event descriptors stored in the mobile communication device. Similarly, information may be received by the mobile communication device from local wireless sources by, for example, infrared communication sources, wireless local area networks such as those conforming to well known IEEE 802.11 specification, or the so called Bluetooth specification as described on the Internet at the uniform resource locator (URL) http://www.bluetooth.org. These wireless sources may be, for example, kiosks set up in public places, such as airports or hotels, for example, for the purpose of broadcasting information to appropriately equipped mobile communication devices. These kiosks may be used for alternative purposes, such as advertising, or to command mobile communication devices to prompt users to turn off the mobile communication device when embarking on airline travel. These sources may provide explicit geographic location information, or the geographic location may be inferred simply by the presence of the signal, indicating a new location has been reached.

Once the mobile communication device 101 has determined an event has occurred corresponding to an event defined by one or more event descriptors, the mobile communication device may automatically transmit a status response message, or it may prompt the user of the mobile communication device 101 before transmitting the status response message. The status response message may be sent directly from the mobile communication device 101 a pre-selected party (101 or 104, for example), or alternatively the mobile communication device can request the communication system send a message according to a predefined event response profile stored on a database 124 of the communication system. In the latter case the user of the mobile communication device has access to the database under an agreement with the communication system operator so the user can configure the event response profile. The status response message can take a variety of forms, such as, for example, a phone call for transmitting a brief announcement, a text message sent via a short message service (SMS) transmission, an email message, and so on. Therefore, once the mobile communication device has determined an event has occurred, and it commences responding, the response may be delivered by a mobile telephony or mobile data channel 124, a standard landline telephony line 126, or a data network 128.

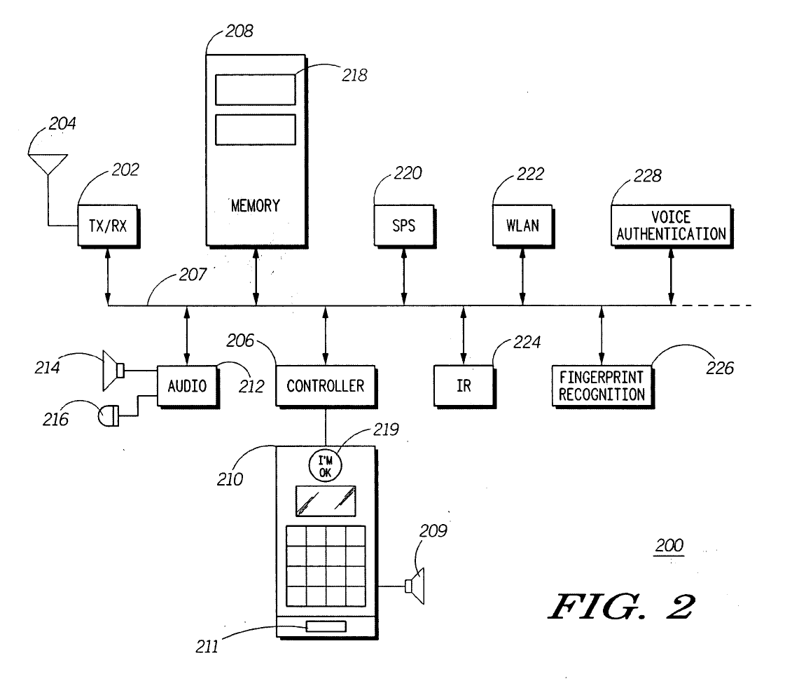

Referring now to FIG. 2, there is shown a block schematic diagram of a mobile communication device 200 having personal status reporting capability in accordance with the invention. The mobile communication device 200 comprises a radio frequency transceiver 202 for modulating and transmitting radio signals, and receiving and demodulating radio signals via an antenna 204, as is known in the art. All components of the mobile communication device are operated under control of a processor or controller 206. As shown here the mobile communication device component subsystems are operably coupled to the controller 206 via a bus 207, but the controller 206 may have direct connections to each subsystem, such as a serial interface, or there can be a combination of bus and direct connectivity. The controller 206 executes machine readable code stored in a memory 208, and can have local memory as well. The memory shown here is an abstract representation of various kinds of memory the mobile communication device 200 can have, such as RAM, ROM, reprogrammable and so on. The controller 206 is linked to a user interface 210 typically including a display device for displaying information to the user and a keypad or button assembly for allowing the user to make selections, input information, and control operation of the mobile communication device 200. The user interface 210 can also include other elements such as a mechanical vibrator 211, an audio transducer 209 for producing sounds, and light producing elements for other visual indications or backlighting the display or keypad and buttons. To facilitate voice and audio communication, the mobile communication device comprises an audio processor 212 which converts digital audio signals received from the transceiver into analog signals that are played over a speaker 214. The audio processor 212 can also receive analog signals from a microphone 216 and converts them to digital audio signals which are provided to the transceiver 202. It is also contemplated that the mobile communication device 200 can include a video recording device for capturing images and video footage with the mobile communication device, and stored in the memory of the mobile communication device 200, or in an auxiliary memory contained in a peripheral device attached to the mobile communication device 200. It is further contemplated that a scent detection subsystem or other biometric sensing device can be included in the mobile communication device to detect various scents or other changing biometric information, as determined by the user. The communication device 200 can also include a scent generating device as well for purposes of alerting the user as further discussed below.

The mobile communication device 200 operates in part according to machine readable code disposed in the memory. The instruction code is developed in code modules which each perform certain tasks, applications, and operations, and set up various modes of operation and processes. One such set of modules controls the operation of an event monitoring mode, which may be activated or deactivated by the user. When the event monitoring mode is activated, the mobile communication device compares input it receives with one or more event descriptor files 218, which are also stored in memory, and can be created, edited, and deleted by the user. When the event monitoring mode is invoked, the mobile communication device 200 compares input received from various subsystem components with criteria in the event descriptor files. When the inputs are close enough to be considered a match, the event is generated, meaning the mobile communication device takes action to send a status response message. The mobile communication device may comprise, for example, a satellite positioning subsystem 220 for receiving satellite positioning signals from satellite positioning satellites and determining a precise present geographic location of the mobile communication device. Geographic location can be determined, with less precision, from other information, such as, for example, control information received at the transceiver from the communication system as many communication system base stations transmit information relating to their geographic location. The mobile communication device 200 can also include wireless receivers for receiving information from local sources, such as an infrared subsystem 224 or a wireless local area network subsystem 222. These subsystems can receive information from local sources such as kiosks located in public places like airports and shopping centers, as mentioned hereinabove.

Alternatively, it is contemplated that the event can be a status inquiry message received at the mobile communication device 200 via the communication system. Reception of the message is treated like any other event that can be described in an event descriptor file.

Once the mobile communication device 200 has determined that an event has occurred, the mobile communication device can either automatically send a status message, or prompt the user and wait for an input before sending the status message. In prompting the user, the mobile communication device may use a variety of alert devices to get the user's attention, such as audio, visual and tactile alerts generated via the user interface, or even by means of a scent generated in response to the event. For example the mobile communication device can turn on a light element that backlights a status response button 219. The mobile communication device 200 can also display a message on the display, turn on the mechanical vibrator 211, or play a sound on the speaker transducer 209, or any combination of these. Furthermore, the user can indicate how to alert the user in the event descriptor file. Once the user recognizes the prompt, the user may then respond by, for example, pressing a status response button. In some cases it may be desirable for the user to prove their identity, and thus the mobile communication device will authenticate the user. For example, if the event is the reception of a status query message, the person making the inquiry may want some assurance that the status message response was generated by the intended person.

There are a variety of means for authenticating the user of the mobile communication device, each with varying levels of complexity and corresponding assurance that the present operator of the mobile communication device is the correct person to respond to the event prompt. The simplest being a password challenge. The user provides a password to the mobile communication device before the event occurs. The password may be a general password for the mobile communication device, as is common, or the password may be provided in the event descriptor. More sophisticated means of authentication may be employed, such as a fingerprint recognition module 226 or a voice recognition authentication module 228. As can be appreciated, other forms of identification can be utilized (e.g. IRIS Scan or facial image recognition) within contemplation of the scope of the appended claims. The fingerprint module works with special hardware disposed on the mobile communication device for receiving an optical scan of the user's fingerprint. The fingerprint is compared to the stored record of the user's fingerprint for authentication. Similarly, the voice recognition authentication module receives a speech segment of the user's voice, such as from the audio processor, and compares it to a stored version of the speech segment for authentication. The speech recognition module, although shown here as a module, may be entirely implemented by a digital signal processor of the mobile communication device executing voice recognition instruction code. Since digital signal processors are commonly used in mobile communication devices, this form of authentication requires only the voice recognition instruction code, which is also fairly common in present-day mobile communication devices. It is also contemplated that the mobile communication device 200 can comprise biometric sensors, or alternatively, the mobile communication device can use the WLAN subsystem to communicate with a biometric sensor worn by the user. The biometric sensors can read heart rate, skin temperature, and so on. These metrics may then be reported in the status message.

The communication device 200 of FIG. 2 can be similar to communication device 102 of FIG. 1 and can be a personal and family security device that provides a message response that is triggered by a change in context at the communication device 102. The communication device 102 will report its status in a message response to a receiving device such as communication device 101 or 104.

The message response can take the form of a Message Read (MR) Flag in response to an “I'm OK” message that is monitored in context of the sender's environment. If the MR flag is received “after” a time period defined by the context of the receiver of the MR flag, then a new update is triggered/generated or requested from the sender in accordance with embodiments herein.

The context of the receiver of a message response such as an MR flag along with a profile of the one or more family members receiving the I'm OK message request can be used to determine if an updated “I'm OK” message is required to be sent in response to the “Message Read” status.

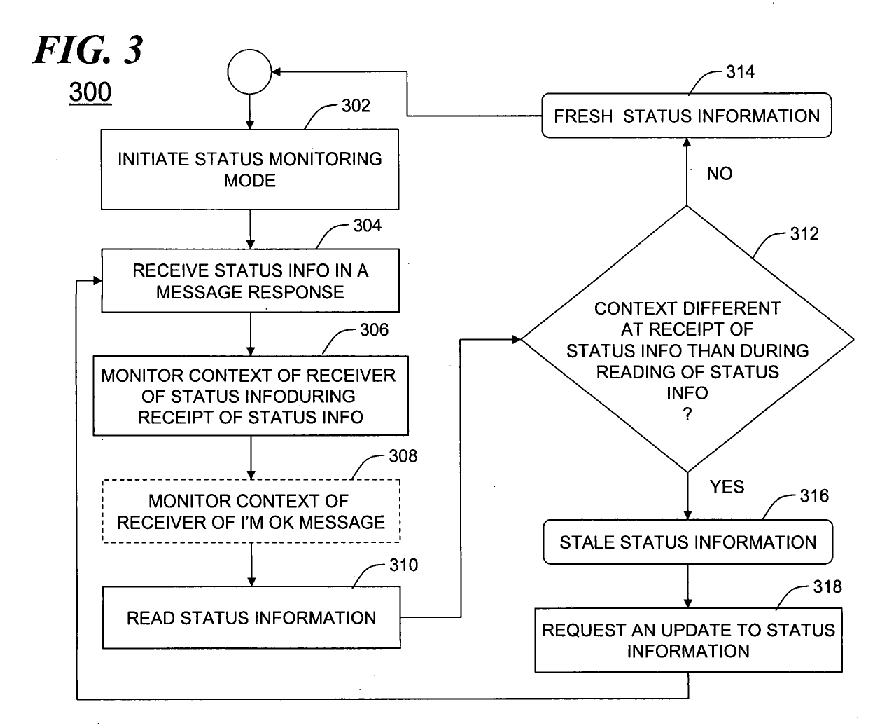

Referring to FIG. 3, a method 300 of gauging message freshness in terms of context can include the steps 302 of initiating a status monitoring mode and step 304 of receiving status information in a message response. The method 300 can further include the step 306 of monitoring the context of the receiver of the status information during receipt of the status information. Such monitoring step can include determining if a message response is stale from the context of a receiver of the message response. In one optional step, the step of monitoring can further include the step 308 of monitoring the context of a receiver of an “I'm OK” message. The method 300 can also monitor when the status information is read at step 310. At decision block 312, the receiver of status information or a message response can determine of the context at or during the receipt of the status information is different from the context at or during the reading of the status information. If the message is determined as fresh at step 314, then the method 300 returns to step 302. The status information is determined as stale if the context is determined as different at step 316 and sending a request for a second message response is sent at step 318. Determining if the message response is stale can be done by determining if the message response is sent after a predetermined time after receipt of the message response or by determining if the message response is sent after an estimated time after a request for the message response or by determining if the message response is sent from an unanticipated location or in response to an unanticipated event as defined in a profile in the receiver of the message response. Determining if the message response is stale can also be done by determining if the message response is read in a location that is different from the location where the message response was received or by determining if the message response is read during an event that is different from an event occurring during receipt of the message response. In one particular embodiment, the method can further monitor a Message Read (MR) Flag (as the message response) of an “I'm OK” message (or message request) in context of the receiver of the MR Flag or an environment of the receiver of the MR Flag. The method can further generate the request for the second message response if the MR flag is received after a predetermined time period defined by the context of the user of the receiver of the MR Flag. The context of the receiver of the MR Flag along with a profile of one or more members receiving the I'm OK message can be used to determine if an updated “I'm OK” message is required to be sent in response to the MR Flag.

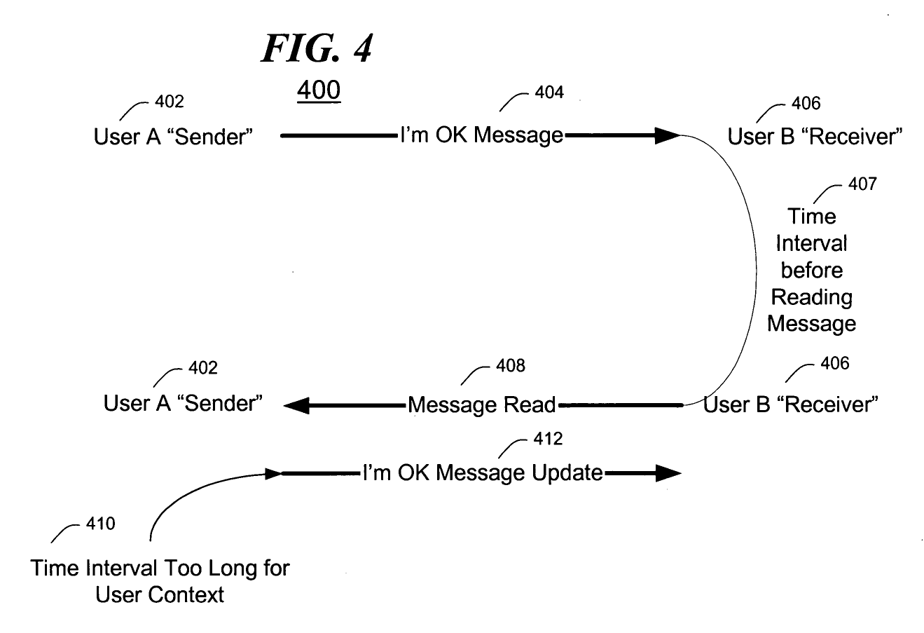

Referring to FIG. 4, a timing diagram 400 again illustrates a method of gauging message freshness. The context of a User A 402 (Sender of a message response such as an I'm OK message 404) is based on the changes of the user's personal environment. Contexts effecting the environment can include the user's movement beyond a virtual geographical fence with the “I'm OK” originating message as the point of origin, the movement of the user to an unknown cellular tower (historical tracking by the device of cell identification towers), or a new calendar event transition from when the original “I'm OK” message was sent, e.g. transition from Band Practice to Homework with a friend.

In another aspect, a time interval 410 can be specified by the profile of User B 406 within User A's device. In this use case, the device of User A 402 can automatically send an updated “I'm OK Message” 412 when a Message Read response 406 has been received after the time specified in the profile for User A based on the time interval 407.

Embodiment in accordance with the present invention can provide reliable means of reporting the status of family members within a personal and family security environment. This reliability is accomplished by updating an initial “I'm OK” message when it has been determined the “I'm OK” status is stale.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of gauging message freshness in terms of context, comprising the steps of:
determining if a message response is stale from the context of a receiver of the message response; and
sending a request for a second message response if the message response is determined as being stale.

2. The method of claim 1, wherein the step of determining if the message response is stale comprises determining if the message response is sent after a predetermined time after receipt of the message response.

3. The method of claim 1, wherein the step of determining if the message response is stale comprises determining if the message response is sent after an estimated time after a request for the message response.

4. The method of claim 1, wherein the step of determining if the message response is stale comprises determining if the message response is sent from an unanticipated location as defined in a profile in the receiver of the message response.

5. The method of claim 1, wherein the step of determining if the message response is stale comprises determining if the message response is sent in response to an unanticipated event as defined in a profile of the receiver of the message response.

6. The method of claim 1, wherein the step of determining if the message response is stale comprises determining if the message response is read in a location that is different from the location where the message response was received.

7. The method of claim 1, wherein the step of determining if the message response is stale comprises determining if the message response is read during an event that is different from an event occurring during receipt of the message response.

8. The method of claim 1, wherein the step of determining comprises monitoring a Message Read (MR) Flag of an “I'm OK” message in context of the receiver of the MR Flag or an environment of the receiver of the MR Flag.

9. The method of claim 8, wherein the method further comprises the step of generating the request for the second message response if the MR flag is received after a predetermined time period defined by the context of the user of the receiver of the MR Flag.

10. The method of claim 8, wherein the context of the receiver of the MR Flag along with a profile of one or more members receiving the I'm OK message is used to determine if an updated “I'm OK” message is required to be sent in response to the MR Flag.

11. A wireless communication device capable of gauging message freshness in context of a receiver of a message response, comprising:
a transceiver;
a processor coupled to the transceiver, wherein the transceiver is programmed to:
determine if a message response is stale from the context of the receiver of the message response; and
send a request for a second message response if the message response is determined as being stale.

12. The wireless communication device of claim 11, wherein the communication device is programmed to determine if the message response is stale by determining if the message response is sent after a predetermined time after receipt of the message response.

13. The communication device of claim 11, wherein the communication device determines if the message response is stale by determining if the message response is sent after an estimated time after a request for the message response.

14. The communication device of claim 11, wherein the communication device determines if the message response is stale by determining if the message response is sent from an unanticipated location or during an unanticipated event as defined in a sender's profile or a receiver's profile.

15. The communication device of claim 11, wherein the communication device determines if the message response is stale by determining if the message response is read in a location that is different from the location where the message response was received.

16. The communication device of claim 11, wherein the communication device determines if the message response is stale by determining if the message response is read during an event that is different from an event occurring during receipt of the message response.

17. The communication device of claim 11, wherein the communication device determines if a message is stale by monitoring a Message Read (MR) Flag of an “I'm OK” message in context of the receiver of the MR Flag or an environment of the receiver of the MR Flag.

18. The communication device of claim 17 wherein the communication further generates the request for the second message response if the MR Flag is received after a predetermined time period defined by the context of the user the receiver of the MR Flag.

19. The communication device of claim 17, wherein the communication device uses the context of the of the user of the receiver of the MR Flag along with a profile of one or more members receiving the I'm OK message to determine if an updated “I'm OK” message is required to be sent in response to the MR Flag.

20. A machine-readable storage, having stored thereon a computer program having a plurality of code sections executable by a machine for causing the machine to perform the steps of.
determining if a message response is stale from the context of a sender; and
sending a request for a second message response if the message response is determined as being stale.
